(19) United States
(12) Patent Application Publication
(10) Pub. No.: US 2014/0019787 A1
(43) Pub. Date: Jan. 16, 2014

(54) INFORMATION PROCESSING APPARATUS THAT CONTROLS SUPPLY OF POWER FROM SECONDARY BATTERY TO LOAD

(71) Applicant: Canon Kabushiki Kaisha, Tokyo (JP)

(72) Inventor: Masahiro Kurahashi, Tokyo (JP)

(21) Appl. No.: 13/938,304

(22) Filed: Jul. 10, 2013

(30) Foreign Application Priority Data
Jul. 10, 2012 (JP) 2012-154613

(51) Int. Cl. G06F 1/32

(52) U.S. Cl. CPC G06F 1/3284
USPC 713/323

(57) ABSTRACT

An information processing apparatus which makes it possible to reduce the number of times of charge and discharge to and from a battery. An apparatus power supply supplies power to a RAM. A secondary battery supplies power to the RAM when power supply to the RAM by the apparatus power supply is stopped. In a case where power supply to the RAM by the apparatus power supply is stopped neither at a preset time nor after lapse of a predetermined time period, a CPU controls so that power supply to the RAM is executed by the secondary battery, and, in a case where power supply to the RAM by the apparatus power supply is stopped at the preset time or after lapse of the predetermined time period, the CPU does not control so that power supply to the load is executed by the battery.

### BACKGROUND OF THE INVENTION

1. Field of the Invention

The present invention relates to an information processing apparatus that controls supply of power from a secondary battery to a load, and more particularly to charge and discharge control of a secondary battery incorporated as a backup power source, which is executed during a power failure and in an automatic power-off mode.

2. Description of the Related Art

In an image processing apparatus, such as a facsimile machine or a digital multifunction peripheral, a secondary battery, such as a lithium battery or a nickel-hydrogen battery, is used as a power source for temporary backup when power supply of from a commercial power source (AC power supply) to the apparatus is cut off. For example, when the power supply from the commercial power source is cut off e.g. due to a power failure, power is supplied from the secondary battery, whereby it is possible to continuously hold data stored in a volatile memory, such as a DRAM, incorporated in the apparatus. Thus, when the power supply from the commercial power source is cut off due to a power failure, power starts to be supplied from the secondary battery so as to positively continue to hold the data during the power failure. This state can continue until the charge level of the secondary battery is reduced to zero. In a case where power starts to be supplied from the commercial power source after recovery from the power failure, if the charge level of the secondary battery is low, electric charge to the secondary battery is started.

However, even when no power failure occurs, electric charge and discharge to and from the secondary battery are repeatedly executed whenever the power supply from the commercial power source is cut off and restarted. The service life of the secondary battery considerably depends on the number of times of charge and discharge, and therefore, if a power failure can be reliably detected, it is possible to prevent wasteful consumption of power stored in the secondary battery and unnecessary charge and discharge to and from the same. In this connection, there has been proposed a control method in which power supply is switched after detection of a power failure e.g. in Japanese Patent Laid-Open Publication No. 2003-136814.

In a multifunction peripheral equipped with a facsimile function, data to be backed up is generally image data which is to be sent and image data which was sent and image data which was received by FAX communication, and hence power supply is not cut off every day.

In recent years, however, some multifunction peripherals with a facsimile function are equipped with an auto-shutoff function for automatically turning off a power supply using a timer at a predetermined time every day or intentionally cutting off the power supply from a commercial power source at a quitting time, for energy saving. For this reason, in such a multifunction peripheral, the number of times of charge and discharge to and from the secondary battery as a backup power source has been sharply increased compared with the conventional ones, and hence there is a fear that the service life of the secondary battery is shortened. To avoid this, it is required to employ an expensive long-life battery or to change batteries halfway through operation, which can undesirably cause an increase in total cost.

Further, the method disclosed in Japanese Patent Laid-Open Publication No. 2003-136814 is not configured to identify a cause of a power-off and then control a charge and discharging method according to the cause of the power-off.

### SUMMARY OF THE INVENTION

The present invention provides an information processing apparatus which makes it possible to reduce the number of times of charge and discharge to and from a secondary battery even in an environment where power-on and power-off are repeatedly executed e.g. by an auto-shutoff function, to thereby prevent the life of the secondary battery being shortened without an increase in costs.

The present invention provides an information processing apparatus comprising a load, a power source configured to supply power to the load, a battery configured to supply power to the load when supply of power to the load by the power source is stopped, a control unit configured, in a case where supply of power to the load by the power source is stopped neither at a preset time nor after lapse of a predetermined time period, to control so that supply of power to the load is executed by the battery, and, in a case where supply of power to the load by the power source is stopped at the preset time or after lapse of the predetermined time period, not to control so that supply of power to the load is executed by the battery.

According to the present invention, when a power failure occurs, power is reliably supplied to the memory from the battery, whereas when the power is turned off by a user, the supply of power to the memory from the battery is stopped. This makes it possible to prevent the battery from being charged uselessly when the power is turned on again after being turned off by the user. This makes it possible to reduce the number of times of charge and discharge to and from the battery to thereby prolong the service life of the battery.

Further features of the present invention will become apparent from the following description of exemplary embodiments with reference to the attached drawings.

### BRIEF DESCRIPTION OF THE DRAWINGS

FIG. 1 is a diagram of the system configuration of an image processing apparatus to which is applied an information processing apparatus according to a first embodiment of the present invention.

FIG. 2 is a diagram of a charge circuit for a secondary battery provided in the image processing apparatus shown in FIG. 1.

FIG. 3 is a diagram useful in explaining a difference in charge current between a continuous charging method and a trickle charging method.

FIG. 4 is a flowchart of a charging control process executed on the charge circuit in FIG. 2.

FIG. 5 is a flowchart of a secondary battery discharge process executed in a step in FIG. 4.

FIG. 6 is a block diagram useful in explaining a method of controlling power supply to a RAM from the secondary battery in the charge circuit in FIG. 2.

FIGS. 7A and 7B are schematic diagrams of a power switch, in which FIG. 7A shows a switch-on state, and FIG. 7B shows a switch-off state.

FIG. 8 is a diagram of an example of a reference table for use in identifying a cause of a power-off based on respective latching states of a first latch circuit and a second latch circuit.

FIG. 9 is a flowchart of a charging control process executed by the information processing apparatus according to the first embodiment.

FIG. 10 is a flowchart of a charging control process executed by an information processing apparatus according to a second embodiment of the present invention.

FIGS. 11A to 11D are diagrams showing changes in terminal voltages of the power switch after a power-off.

### DESCRIPTION OF THE EMBODIMENTS

The present invention will now be described in detail below with reference to the accompanying drawings showing embodiments thereof.

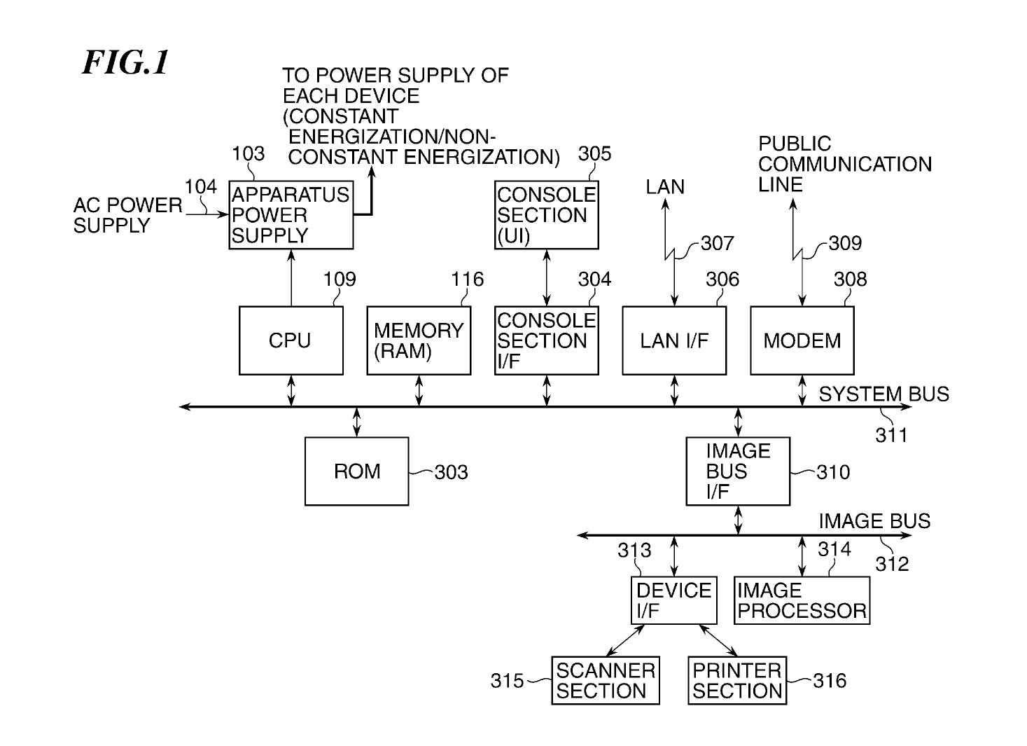

FIG. 1 is a diagram of an example of the system configuration of an image processing apparatus to which is applied an information processing apparatus according to a first embodiment of the present invention.

As the image processing apparatus to which is applied the information processing apparatus of the present embodiment, there may be mentioned a facsimile machine, an MFP (multifunction peripheral), a digital multifunction peripheral, and so forth. The present invention is particularly suitable for an image processing apparatus which is not provided with a nonvolatile storage device (a hard disk drive, a semiconductor disk drive, or the like).

A CPU 109 functions as a controller that controls the overall operation of the system. A RAM 116 is a volatile memory such as a DRAM. The RAM 116 is used by the CPU 109 as a system work memory for operation thereof and an image memory for temporarily storing image data. In the present embodiment, the RAM 116 is backed up by a secondary battery, described hereinafter.

A ROM 303 functions as a boot ROM that stores a boot program for the system. A console section interface 304 provides interface with a console section (user interface) 305, and outputs to the console section 305 image data to be displayed thereon. Further, the console section interface 304 serves to transfer information input by a user of the present system via the console section 305 to the CPU 109.

A network interface (LAN I/F) 306 is connected to a LAN 307 to input and output information. A modem 308 is connected to a public communication line 309 to input and output information.

The above-mentioned devices are arranged on a system bus 311 to exchange information with each other via the system bus 311.

An image bus interface 310 is a bus bridge that connects between the system bus 311 and an image bus 312 for high-speed transfer of image data. The image bus interface 310 converts data structure. The image bus 312 is implemented by a high-speed bus, such as a PCI bus. Note that on the image bus 312, there are arranged devices described hereafter.

A device interface 313 connects a scanner section 315 and a printer section 316, as image input and output devices, to the image bus 312, and performs synchronous-to-asynchronous or asynchronous-to-synchronous conversion of image data. An image processor 314 performs correction, processing, and editing of input image data, or correction, resolution conversion, etc. on image data to be printed out.

An apparatus power supply 103 performs AC/DC conversion and DC/DC conversion of power from an AC power supply 104 to thereby generate power to be supplied into the apparatus.

In the image processing apparatus of the present embodiment, when FAX reception is performed, received image data is temporarily stored in the RAM 116. Further, the present image processing apparatus is capable of performing memory reception (i.e. reception of image data by a method including storing the received image data in a memory for output of an image onto a recording sheet in designated timing) in response to an instruction from the user. When FAX reception is performed in a state where recording sheets have run out, received image data is held in the RAM 116 without being output onto a recording sheet.

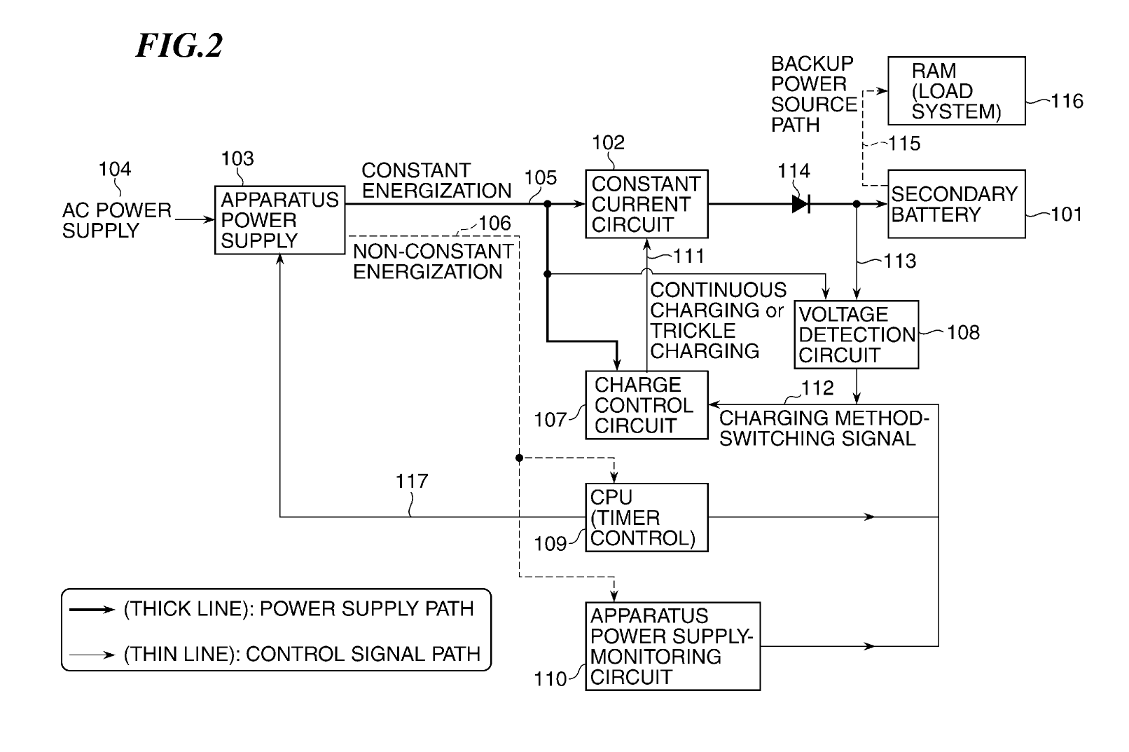

If power supply from the AC power supply 104 to the apparatus is cut off e.g. due to a power failure, with received image data being held in the RAM 116, there is a fear that the image data or the like stored in the RAM 116 is lost. To eliminate this inconvenience, the self-refreshing of the RAM 116 is backed up by a secondary battery 101(see FIG. 2).

When the supply of power to the apparatus is restored in a state where the RAM 116 is executing self-refreshing using the secondary battery 101 as a backup power source, the CPU 109 determines whether or not information stored in the RAM 116 has been backed up. If the information stored in the RAM 116 has been backed up, the information is handled as a FAX-received image.

Next, a description will be given of the circuit configuration of a charge circuit in the image processing apparatus in FIG. 1.

FIG. 2 is a diagram of the charge circuit for the secondary battery provided in the image processing apparatus in FIG. 1. Thick lines (solid lines and broken lines) in FIG. 2 show power supply paths, respectively, and thin lines indicate transmission paths of respective control signals.

From the apparatus power supply 103 extend a constant-energization power supply path 105 and a non-constant-energization power supply path 106. The non-constant-energization power supply path 106 is configured to be cut off when the apparatus shifts to “a power saving mode” (also referred to as “an energy saving mode”) so as to reduce power consumption in a standby state. After the apparatus has shifted to “the power saving mode”, the apparatus power supply 103 receives a non-constant power supply OFF signal from the CPU 109 via a signal path 117 and cuts off the non-constant-energization power supply path 106.

The constant-energization power supply path 105 is used to supply power to electric circuits required to remain energized so as to enable requisite minimum functions even after shifting to “the power saving mode”. The supply of power through the constant-energization power supply path 105 is never cut off even after shifting to “the power saving mode”.

The secondary battery 101 is charged with power supplied from the AC power supply 104, such as a commercial power source. The secondary battery 101 is charged using the constant-energization power supply path 105. More specifically, charging of the secondary battery 101 is performed with a constant current supplied via a constant current circuit 102 connected to the constant-energization power supply path 105.

The constant current circuit 102, which is required to perform switching of a charging method for the secondary battery 101, is operated by power supplied via the constant-energization power supply path 105. The constant current circuit 102 switches the charging method for the secondary battery 101 between a continuous charging method of rapidly and continuously charging the secondary battery 101 with a relatively large current and a trickle charging method of charging the secondary battery 101 for compensating for only an amount of power lost by self-discharge of the secondary battery 101, based on a charge control signal sent from a charge control circuit 107 via a signal path 111.

A voltage detection circuit 108 is operated by power supplied via the constant-energization power supply path 105, to constantly monitor a battery voltage 113 of the secondary battery 101. For example, when the battery voltage 113 exceeds a predetermined voltage, a charging method-switching signal is output from the voltage detection circuit 108 to the charge control circuit 107 via a signal path 112.

Upon receipt of the charging method-switching signal from one of the voltage detection circuit 108, the CPU 109, and an apparatus power supply-monitoring circuit 110, via the signal path 112, the charge control circuit 107 generates a charge control signal for switching the continuous charging method to the trickle charging method, and sends the generated signal to the constant current circuit 102 via the signal line 111.

The CPU 109 has a timer circuit that counts time from the start of charging of the secondary battery 101, and notifies the charge control circuit 107 of the lapse of a predetermined time period. When the predetermined time period elapses after the start of charging, the CPU 109 outputs the charging method-switching signal to the charge control circuit 107 via the signal path 112.

The apparatus power supply-monitoring circuit 110 is provided to detect the cutoff of the non-constant-energization power supply path 106, e.g. due to shifting to the power saving mode. When the cutoff of the power supply path 106 is detected, the charging method-switching signal is output from the apparatus power supply-monitoring circuit 110 to the charge control circuit 107 via the signal path 112.

When the AC power supply 104 is turned off e.g. due to a power failure, power supply from the apparatus power supply 103 is completely cut off. In this case, power supply from the secondary battery 101 to the RAM 116 is automatically started via a backup power source path 115. Note that a diode 114 is a backflow prevention device disposed so as to prevent current from flowing back into a circuit upstream of the constant current circuit 102 during supply of backup power from the secondary battery 101.

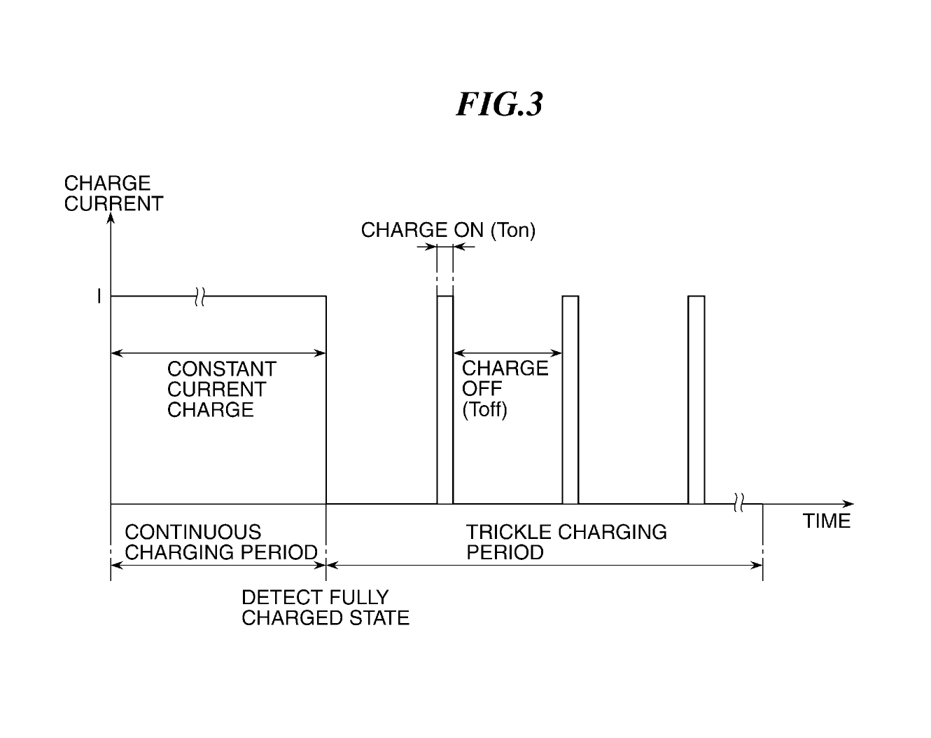

Next, a description will be given, with reference to FIG. 3, of a pulse trickle charging method for trickle charging the secondary battery 101 with current pulses.

FIG. 3 is a diagram useful in explaining a difference in charge current between the continuous charging method and the trickle charging method.

As mentioned hereinbefore, trickle charging is performed so as to compensate for a charge loss due to self-discharge of the secondary battery 101 after the secondary battery 101 is fully charged by continuous charging (or a condition equivalent to a fully charged condition is satisfied).

In the charge circuit shown in FIG. 2, charging is performed with a constant current I until a full charge of the secondary battery 101 is detected. After it is detected that the secondary battery 101 has been fully charged, continuous charging is terminated, but charging is performed such that a charging OFF time (Toff) set to a predetermined time period and a charging ON time (Ton) also set to a predetermined time period are alternately repeated. The time Ton and the time Toff vary with the battery capacity, but the time Ton is set such that an amount of current corresponding to an amount of self-discharge per 24 hours (in general, several percent of battery capacity in the case of a nickel-hydrogen secondary battery) can be caused to flow into the secondary battery 101. The relationship between the charging ON time and the charging OFF time is generally set such that Ton<<Toff.

Even when the voltage detection circuit 108 does not detect a fully charged state and the CPU 109 becomes unable to perform count control after cutoff of the non-constant-energization power supply path 106 due to shifting to the power saving mode, the apparatus power supply-monitoring circuit 110 detects the cutoff of the non-constant-energization power supply path 106. As a consequence, the charging method-switching signal is output from the apparatus power supply-monitoring circuit 110 to the charge control circuit 107 via the signal path 112, so that it is possible to prevent the secondary battery 101 from being continuously charged in the continuous charging state, to thereby prevent the secondary battery 101 from being overcharged.

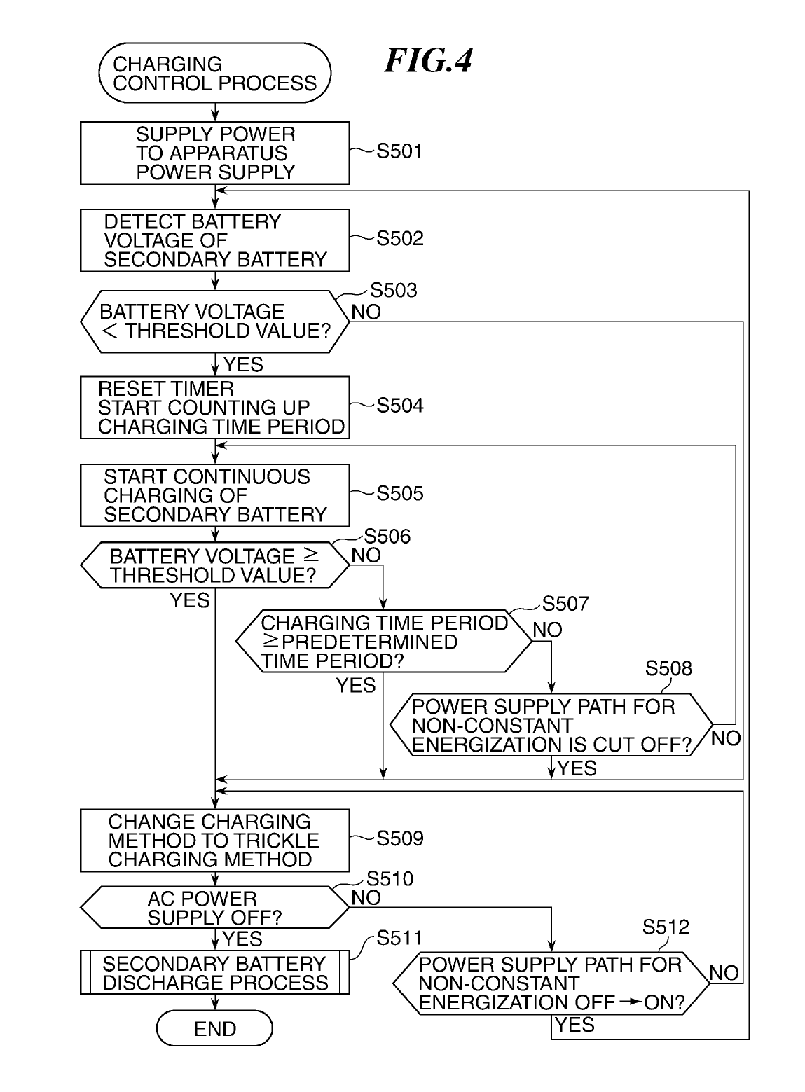

Next, a description will be given, with reference to FIG. 4, of a charging control process executed when the secondary battery 101 is to be charged in the charge circuit shown in FIG. 2.

FIG. 4 is a flowchart of the charging control process executed in the charge circuit in FIG. 2.

Referring to FIG. 4, when power starts to be supplied from the AC power supply 104 (step S501), the voltage detection circuit 108 detects a battery voltage of the secondary battery 101 (step S502).

If the battery voltage of the secondary battery 101 detected by the voltage detection circuit 108 is lower than a predetermined threshold value indicative of the fully charged state (YES to a step S503), the process proceeds to a step S504. On the other hand, if the battery voltage of the secondary battery 101 is not lower than the threshold value from the start of energization by the AC power supply 104 (NO to the step S503), the process proceeds to a step S509, wherein the charging method is switched to the trickle charging method for compensating for only the amount of charge lost by self-discharge.

In the step S504, the CPU 109 resets the timer of the timer circuit and starts counting up the charging time. Approximately at the same time, the CPU 109 starts continuous charging (constant current quick charge) of the secondary battery 101 (step S505).

After the continuous charging is started in the step S505, the charging method is switched from the continuous charging method to the trickle charging method (steps S506 to S508) when any one of the following conditions is satisfied:

1) the battery voltage of the secondary battery 101 has reached or exceeded the predetermined threshold value (YES to the step S506);

2) the charging time reaches or exceeds a predetermined time period (YES to the step S507); and

3) the non-constant power supply path 106 is cut off due to shifting to the power saving mode (YES to the step S508).

If none of the above-mentioned conditions are satisfied, the continuous charging continues to be executed (step S505).

In the steps S509 et seq., the fully charged state of the secondary battery 101 is maintained by the trickle charging so as to be prepared for unexpected turn-off of the AC power supply 104. If the AC power supply 104 is turned off (YES to a step S510), a discharge process for discharging the secondary battery 101 is executed (step S511).

On the other hand, if the charging method is switched to the trickle charging according to satisfaction of the condition of the step S508 (i.e. the non-constant power supply path 106 is OFF), the process returns to the step S502 on condition that the answer to the question of a step S512 is affirmative (i.e. the non-constant power supply path 106 is turned ON) (YES to a step S512), and the charging control process is repeatedly executed. The reason for this is that in a case where the charging method is switched to the trickle charging method due to cut-off of the non-constant power supply before the secondary battery 101 is fully charged, it is required to restart the continuous charging so as to fully charge the secondary battery 101 again after the non-constant power supply path is restored.

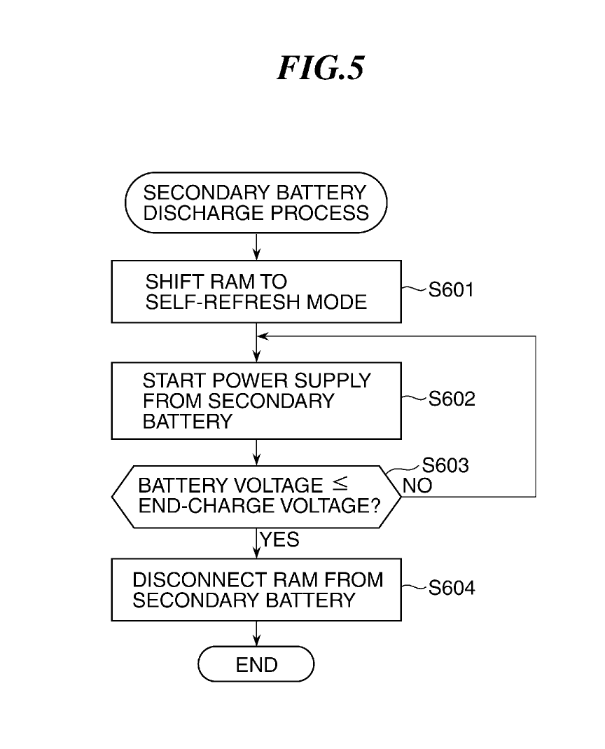

Next, the secondary battery discharge process executed in the step S511 in FIG. 4 will be described in detail with reference to FIG. 5.

FIG. 5 is a flowchart of the secondary battery discharge process executed in the step S511 in FIG. 4.

Referring to FIG. 5, when the OFF state of the AC power supply 104 is detected, the CPU 109 shifts the RAM 116, which is to be backed up, to the self-refresh mode (step S601). Approximately at the same time, power starts to be supplied to the RAM 116 from the secondary battery 101 (step S602).

During the supply of power to the RAM 116 from the secondary battery 101, the battery voltage is detected by the voltage detection circuit 108, and when the battery voltage reaches a predetermined end-of-charge voltage (YES to a step S603), the RAM 116 is disconnected from the secondary battery 101 (step S604).

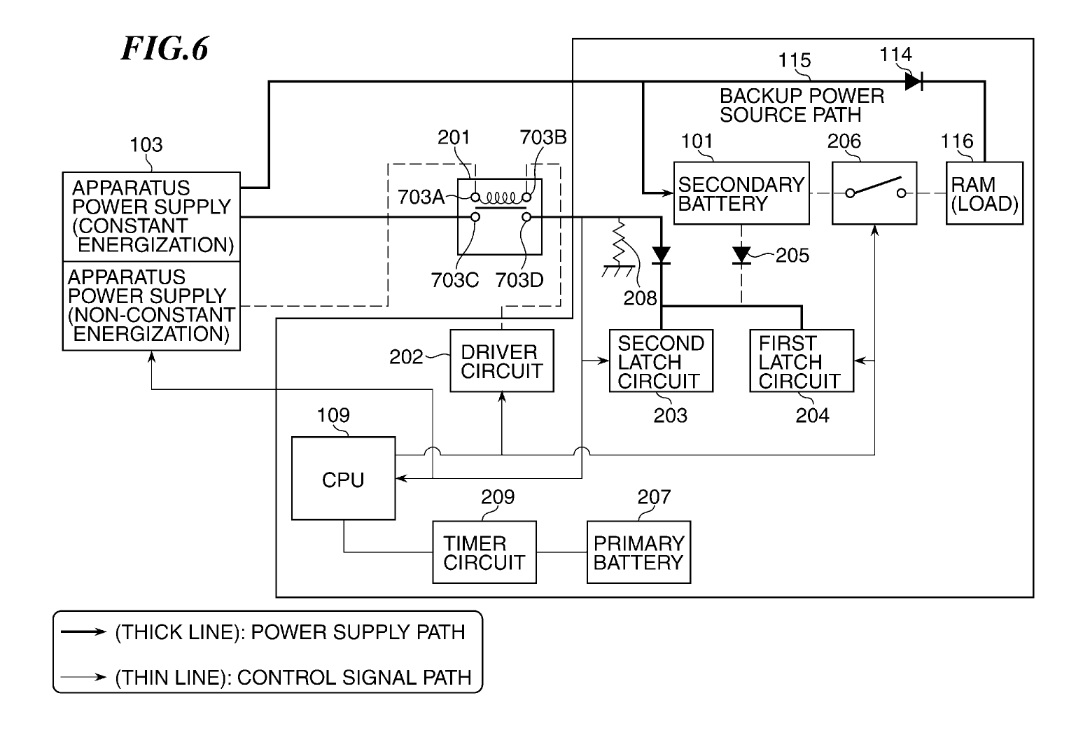

FIG. 6 is a block diagram useful in explaining a method of controlling power supply to a RAM from the secondary battery in the charge circuit in FIG. 2.

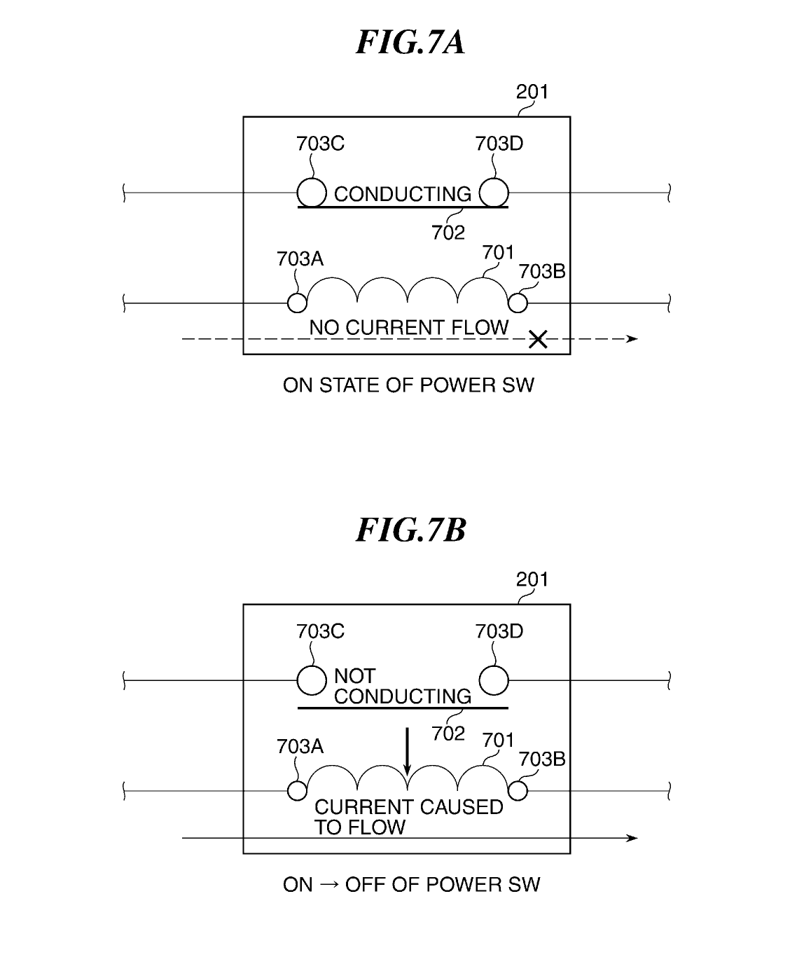

Reference numeral 201 denotes a power switch incorporating a latching solenoid. The configuration and operation of the power switch 201 will be described briefly with reference to FIGS. 7A and 7B.

As shown in FIG. 7A, when current is not flowing through an attracting coil 701 provided within the power switch 201, electrical conduction is maintained between a third pin 703C and a fourth pin 703D of the power switch 201.

In switching the power switch 201 from the ON state to the OFF state through software control by the CPU 109, current is caused to flow through the attracting coil 701 to excite the same. This causes an energizing movable portion 702, which has been connecting between the third pin 703C and the fourth pin 703D of the power switch 201, to be attracted toward the attracting coil 701, whereby the electrical conduction between the third pin 703C and the fourth pin 703D is cut off (see FIG. 7B), and thereafter, the cut-off state is continuously held by the holding force of a permanent magnet, not shown, provided within the power switch 201 (operation principle of the latching solenoid). Thus, it is possible to cut off the electrical conduction between the third pin 703C and the fourth pin 703D of the power switch 201, and thereby automatically turn off the power switch 201 by software control.

On the other hand, in the case of switching the power switch 201 from the OFF state to the ON state, the user has to operate the power switch 201 from outside to turn on the same. The power switch 201, which also has a seesaw switch structure, can also be turned off by operation e.g. by the user. Note that the arrangement of the pins of the power switch 201 is not limited to the illustrated example.

With the above-described arrangement, the image processing apparatus can be powered off by an auto-shutoff function. The auto-shutoff function is used to automatically turn off the power supply at a set time. This function is also referred to as the automatic power supply-interrupting function, but in the following, it is referred to as the “auto-shutoff function”. The auto-shutoff function is configured such that the user can enable or disable the auto-shutoff (set the same to ON or OFF) the from the console section 305. When the auto-shutoff is enabled (set to ON), the image processing apparatus shifts to an auto-shutoff mode.

Referring again to FIG. 6, reference numeral 207 denotes a primary battery. The primary battery 207 is connected to a timer circuit 209. Even after the apparatus power supply 103 is cut off, the primary battery 207 supplies power to the timer circuit 209. The timer circuit 209 is connected to the CPU 109. Note that the timer circuit 209 may be incorporated in the CPU 109 or provided as a peripheral circuit connected to the CPU 109 as shown in FIG. 6.

The CPU 109 is capable of perform time setting of the timer circuit 209. The timer circuit 209 sends an interrupt signal or the like to the CPU 109 at a set time or after the lapse of a set time period. Upon receipt of the interrupt signal or the like from the timer circuit 209, the CPU 109 controls a driver circuit 202 to turn off the power switch 201. To turn on the power supply again, a user's operation for switching on the power switch 201 is required.

A first pin 703A of the power switch 201 is supplied with power for non-constant energization from the apparatus power supply 103, while a second pin 703B on the opposite side of the power switch 201 is connected to the driver circuit 202. Further, the attracting coil 701 forming the solenoid is connected between the first and second pins 703A and 703B of the power switch 201.

The driver circuit 202 controls current to be supplied to the attracting coil 701 of the power switch 201, based on a control signal from the CPU 109. The user sets an auto-shutoff time via the console section 305. Upon receipt of a signal indicating that the set auto-shutoff time is reached, from the timer circuit 209, the CPU 109 switches off the power switch 201. Thus, in the circuit shown in FIG. 6, the CPU 109 can switch off the power supply by software control. Although in the illustrated example, the power switch 201 is disposed downstream of the apparatus power supply 103, the power switch 201 may be disposed upstream of the apparatus power supply 103.

A switch 206 is interposed between the secondary battery 101 and the RAM 116. The switch 206 switches between the supply of power from the secondary battery 101 to the RAM 116 and cutoff of the same, according to a control signal from the CPU 109. When the supply of power from the secondary battery 101 to the RAM 116 is cut off by the switch 206, image data and the like stored in the RAM 116 are lost.

A first latch circuit 204 is configured to hold (latch) the control signal from the CPU 109 to the switch 206. When the CPU 109 executes power-off by the software control described above, the first latch circuit 204 holds the control signal (latches) to store an event of the power-off by the software control (ON state the first latch circuit 204). When the power switch 201 is turned on, the CPU 109 checks the state of the first latch circuit 204 to thereby determine whether or not the immediately preceding power-off was executed by the CPU 109. For example, when the state of the first latch circuit 204 is OFF, it is determined that the auto-shutoff by the software control was not executed, but the user turned off the power switch 201 or the power supply was cut off due to a power failure.

When the power switch 201 is in the ON state, the first latch circuit 204 is supplied with power for constant energization from the apparatus power supply 103. When no power for constant energization is supplied due to turn-off of the power switch 201, power is supplied to the first latch circuit 204 from the secondary battery 101 via a diode 205. The diode 205 is provided to prevent current from flowing back during the power supply from the secondary battery 101.

The RAM 116 (load) is supplied with power for constant energization from the apparatus power supply 103 via the diode 114. When the supply of power for constant energization is cut off, power is supplied to the RAM 116 from the secondary battery 101 via the switch 206. A resistor 208 is a pull-down resistor for detecting polarity.

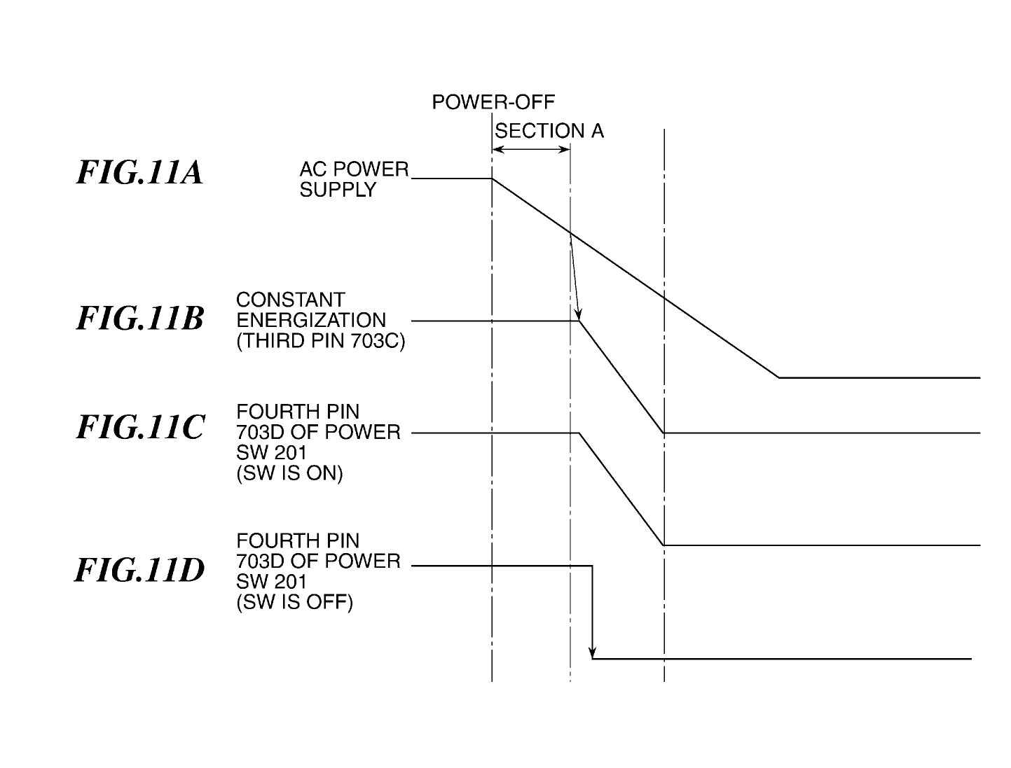

As shown in FIG. 6, a second latch circuit 203 is connected to the fourth pin 703D of the power switch 201. The second latch circuit 203 is configured to hold (latch) presence or absence of power supplied from the apparatus power supply 103 via the power switch 201. When the supply of power is cut off with the power switch 201 held on, output voltage at the fourth pin 703D of the power switch 201 gradually decreases as shown in FIG. 11C. This corresponds to a state where a power failure has occurred. On the other hand, when the supply of power is cut off by turn-off of the power switch 201, the output voltage at the fourth pin 703D of the power switch 201 sharply decreases as shown in FIG. 11D. By detecting the above-mentioned difference, it is possible to determine whether the cut-off of the supply of power is due to a power failure or intentional power-off executed by the user. In the present embodiment, when the output voltage at the fourth pin 703D of the power switch 201 sharply decreases as shown in FIG. 11D, the second latch circuit 203 latches to store this event (ON state of the second latch circuit 203). Note that the same state as shown in FIG. 11D is detected also when the power supply is cut off by the software control.

When the power supply is turned on again after having been turned off due to some cause, the CPU 109 is capable of determining whether the turn-off of the power supply was due to a power failure or some other cause, by checking the state of the second latch circuit 203. The other causes include intentional power-off by the user. When the second latch circuit 203 has not latched (stored no event), it is possible to determine that the turn-off of the power supply was due to a power failure. Thus, the CPU 109 functions as a cause identification unit, for example.

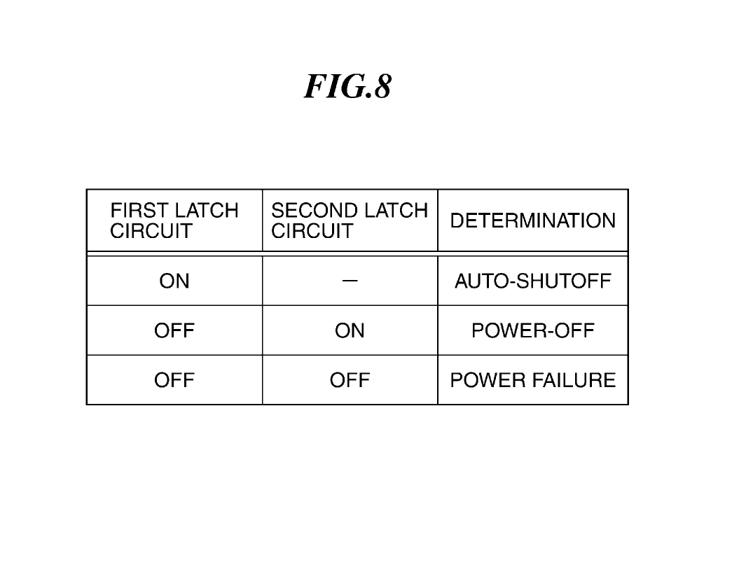

FIG. 8 is a diagram of an example of a reference table for use in identifying a cause of a power-off based on the latching state of the first latch circuit 204 and that of the second latch circuit 203.

When it is determined that the first latch circuit 204 has latched (i.e. the same is in the ON state), the CPU 109 determines from the reference table in FIG. 8 that the power-off was due to the auto-shutoff by the software control. When it is determined that the first latch circuit 204 is in the OFF state and the second latch circuit 203 in the ON state, the CPU 109 determines that the power-off was due to turn-off of the power switch by the user. Further, when the first latch circuit 204 is in the OFF state and the second latch circuit 203 also in the OFF state, the CPU 109 determines that the power-off was due to a power failure.

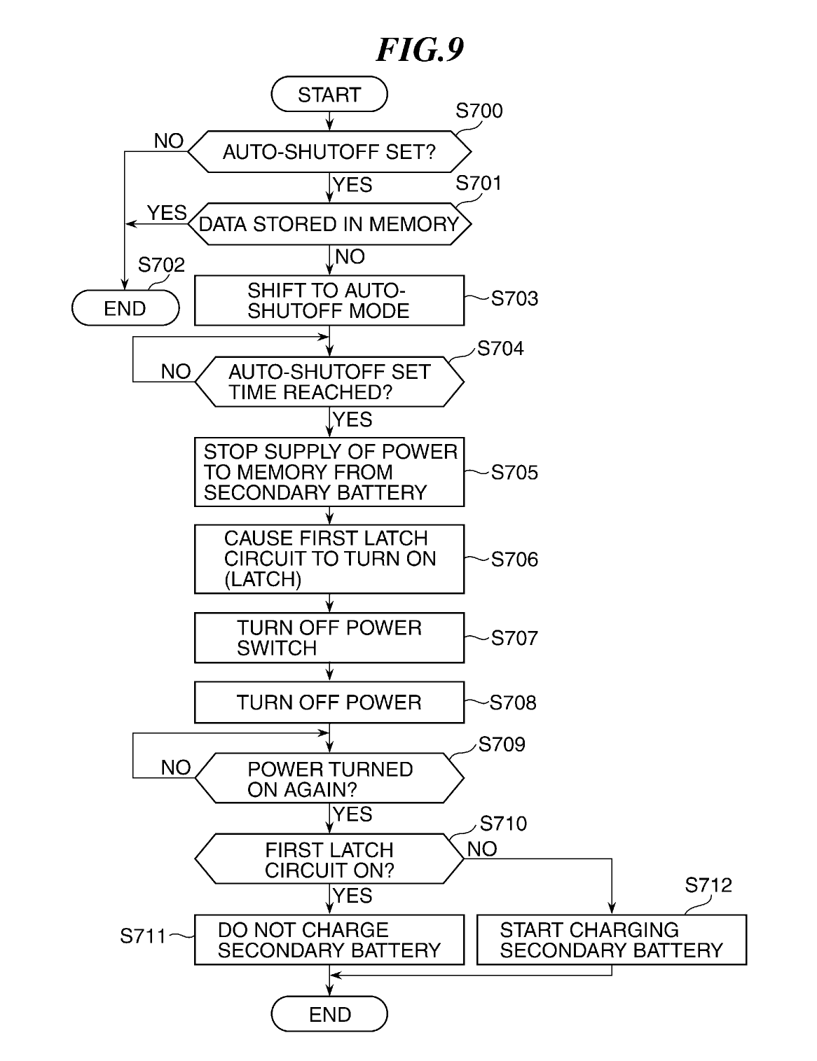

FIG. 9 is a flowchart of a charging control process executed by the information processing apparatus according to the first embodiment. The charging control process is realized by the CPU 109 reading a control program from the ROM 303 and executing the control program.

Referring to FIG. 9, the CPU 109 determines whether or not the auto-shutoff has been set to ON (step S700). If the auto-shutoff has been set to ON, the process proceeds to a step S701. On the other hand, if it is determined that the auto-shutoff has been set to OFF, the present process is immediately terminated (step S702).

In the step S701, the CPU 109 determines whether or not there is data to be continuously held by the RAM 116. When the FAX mode is set to a memory reception mode or when data for FAX transmission is stored in the RAM 116 (YES to the step S701), the present process is immediately terminated (step S702) even though the auto-shutoff has been set to ON. This is because it is required to prevent data to be continuously held by the RAM 116 from being lost due to power-off. On the other hand, if the answer to the question of the step S701 is negative (NO), the CPU 109 shifts to the auto-shutoff mode (step S703).

Then, in a step S704, the CPU 109 determines, using the timer circuit 209, whether or not an auto-shutoff set time set by the user has been reached. If the time has been reached, the process proceeds to a step S705.

In the step S705, the CPU 109 turns off the switch 206 disposed between the secondary battery 101 and the RAM 116, to thereby stop power supply from the secondary battery 101 to the RAM 116. The first latch circuit 204 holds the control signal sent from the CPU 109 to the switch 206 (latches) to store an event of this (set to the ON state) (step S706). Since the power supply from the secondary battery 101 to the RAM 116 is stopped, data stored in the RAM 116 is lost, but the charge level of the secondary battery 101 is hardly lowered.

Then, in a step S707, the CPU 109 causes the driver circuit 202 to turn off the power switch 201 to thereby turn off the power of the image processing apparatus (step S708).

Then, in a step S709, the CPU 109 determines whether or not the power of the image processing apparatus has been turned on. If the power of the image processing apparatus has been turned on, the process proceeds to a step S710. In the step S710, the CPU 109 checks the latching state of the first latch circuit 204 and determines whether or not the first latch circuit 204 has latched. If the first latch circuit 204 has latched (i.e. the same is in the ON state) (YES to the step S710), the CPU 109 determines that the immediately preceding power-off was due to the auto-shutoff by the software control, and then the process proceeds to a step S711. In the step S711, the CPU 109 determines that the stored charge of the secondary battery 101 is hardly reduced, and therefore the secondary battery 101 is substantially fully charged. In this case, the CPU 109 shifts to a standby state without charging the secondary battery 101.

On the other hand, if it is determined in the step S710 that the first latch circuit 204 has not latched (i.e. the same is in the OFF state) (NO to the step S710), the CPU 109 determines that the immediately preceding power-off was not due to the auto-shutoff, but it occurred e.g. due to a power failure, and the process proceeds to a step S712. Note that if it is determined, based on the result of detection by the voltage detection circuit 108, that the secondary battery 101 is not fully charged, the process also proceeds to the step S712.

In the step S712, the CPU 109 starts charging the secondary battery 101. Thereafter, the steps S502 et seq. of the process in FIG. 4 are executed.

In the above-described process, the order of the steps S705 to S707 may be changed.

According to the first embodiment, it is possible to reliably supply power from the secondary battery to the memory during a power failure, while when the power-off is executed by the user, it is possible to stop the power supply from the secondary battery to the memory to thereby prevent useless charging of the secondary battery from being performed after the power is turned on again. This makes it possible to reduce the number of times of charge and discharge to and from the secondary battery to thereby prolong the service life of the battery.

Next, a description will be given of a second embodiment of the present invention. The present embodiment is identical to the above-described first embodiment in configuration shown in FIGS. 1 to 8. Therefore, the same component parts and elements as those of the first embodiment are denoted by the same reference numerals, and description thereof is omitted. The following description is given of only points different from the first embodiment.

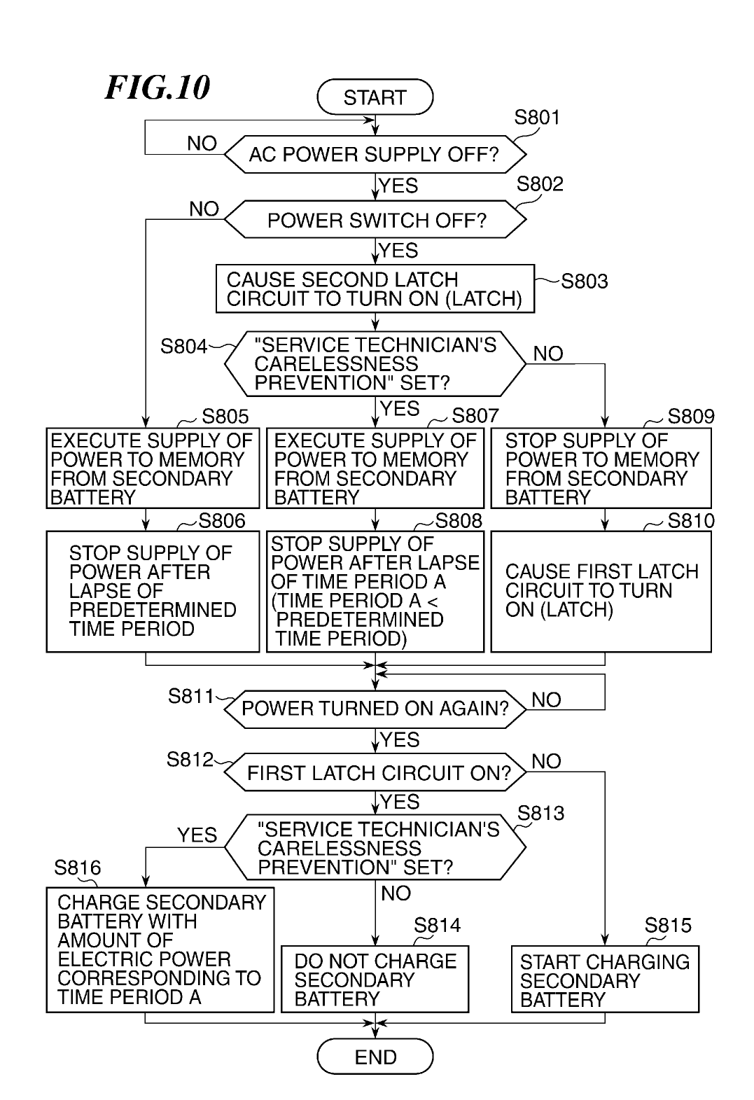

FIG. 10 is a flowchart of a charging control process executed by an information processing apparatus according to the second embodiment. The present process is realized by the CPU 109 reading a control program from the ROM 303 and executing the control program.

In a step S801, the CPU 109 detects whether or not a voltage drop of the AC power supply 104 has occurred to thereby determine whether or not supply of power from the commercial power source has been stopped. The voltage of the AC power supply 104 falls after turn-off of the power supply, as shown in FIG. 11A, but in an A section, the apparatus power supply 103 is in a state supplied with power, as shown in FIG. 11B, so that the CPU 109 can detect the voltage of the AC power supply 104.

In a step S802, the CPU 109 checks the latching state of the second latch circuit 203 and determines whether or not the power switch 201 has been turned off. If the second latch circuit 203 has latched (i.e. the same is in the ON state), the CPU 109 determines that the power switch 201 has been turned off (YES to the step S802) and that the power-off has been executed by the user, and then the process proceeds to a step S803. In the step S803, the latching state (ON state) of the second latch circuit 203 is maintained, and the process proceeds to a step S804. When no power is supplied from the apparatus power supply 103, the second latch circuit 203 is supplied with power from the secondary battery 101, and otherwise, the second latch circuit 203 is supplied with power from the apparatus power supply 103. Therefore, the second latch circuit 203 can hold information until the power supply is turned on (YES to a step S811) next time.

On the other hand, if it is determined in the step S802 that the second latch circuit 203 has not latched, it is determined that the power switch 201 has not been turned off (NO to the step S802), and the CPU 109 judges that the power-off has been caused by a power failure or the like, so that the process proceeds to a step S805. In the step S805 and the following step S806, the CPU 109 causes the secondary battery 101 to supply power to the RAM 116 over a predetermined time period (one hour in the present example), and then stops the supply of power to the RAM 116. Then, the process proceeds to the step S811. Since power is supplied to the RAM 116, the charge level of the secondary battery 101 decreases. Although in the present embodiment, power is supplied from the secondary battery 101 to the RAM 116 over one hour, this time period can be changed, as deemed appropriate, according to product specifications.

In the step S804, the CPU 109 determines whether or not a “service technician's carelessness prevention” has been set. The “service technician's carelessness prevention” is provided to prevent a user from erroneously turning off the power supply during execution of FAX reception in spite of the setting of the memory reception, or a service technician from carelessly turning off the power supply without checking settings at a user's site. The setting of “service technician's carelessness prevention” is configured by the user via the console section 305.

If it is determined in the step S804 that the “service technician's carelessness prevention” has been set, the CPU 109 causes the secondary battery 101 to supply power to the RAM 116 over a predetermined time period A, and stops the supply of power to the RAM 116 after the lapse of the time period A (steps S807 and S808). This power supply time period A is generally set to a shorter time period than the power supply time period (one hour) for power supply executed in the step S806.

On the other hand, if it is determined in the step S804 that the “service technician's carelessness prevention” has not been set, the CPU 109 turns off the switch 206 disposed between the secondary battery 101 and the RAM 116, to thereby stop the power supply from the secondary battery 101 to the RAM 116 (step S809). In response to a control signal sent from the CPU 109 to the switch 206, the first latch circuit 204 latches to store this event (i.e. set to the ON state) (step S810). Since power is not supplied from the secondary battery 101 to the RAM 116, data stored in the RAM 116 is lost. Further, no power is supplied from the secondary battery 101 to the RAM 116, and therefore the charge level of the secondary battery 101 is hardly reduced.

In the step S811, the CPU 109 determines whether or not the power of the image processing apparatus has been turned on. If the power of the image processing apparatus has been turned on, the process proceeds to a step S812. In the step S812, the CPU 109 checks the latching state of the first latch circuit 204 and determines whether or not the first latch circuit 204 has latched. If the first latch circuit 204 has latched (i.e. the same is in the ON state) (YES to the step S812), the process proceeds to a step S813. In the step S813, the CPU 109 determines whether or not the “service technician's carelessness prevention” has been set. If the “service technician's carelessness prevention” has been set, the CPU 109 charges the secondary battery 101 with an amount of electric power corresponding to the time period A over which power is supplied in the step S808 (step S816). If the “service technician's carelessness prevention” has not been set, and the present process is terminated without charging the secondary battery 101 (step S814).

On the other hand, if it is determined in the step S812 that the first latch circuit 204 has not latched (i.e. the same is in the OFF state) (NO to the step S812), the process proceeds to a step S815, wherein the CPU 109 starts charging the secondary battery 101. Thereafter, the steps S502 et seq. in FIG. 4 are executed.

Note that in the above-described process, the steps S804, S807, and S808 can be omitted.

According to the second embodiment, power is reliably supplied from the secondary battery to the memory during a power failure, and when the power of the image processing apparatus is turned off by the user, it is determined whether or not the power-off was due to the user's carelessness. If the power-off was due to the user's carelessness, power is supplied from the secondary battery to the memory over a predetermined time period, whereas if the power-off was intentional, the supply of power is stopped. This makes it possible to prevent the secondary battery from being uselessly charged after the power of the image processing apparatus is turned on again. Consequently, the number of times of charge and discharge to and from the secondary battery is reduced, which makes it possible to prolong the service life of the battery.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2012-154613 filed Jul. 10, 2012, which is hereby incorporated by reference herein in its entirety.

What is claimed is:

1. An information processing apparatus comprising:
a load;
a power source configured to supply power to the load;
a battery configured to supply power to the load when supply of power to the load by the power source is stopped;
a control unit configured, in a case where supply of power to the load by the power source is stopped neither at a preset time nor after lapse of a predetermined time period, to control so that supply of power to the load is executed by the battery, and, in a case where supply of power to the load by the power source is stopped at the preset time or after lapse of the predetermined time period, not to control so that supply of power to the load is executed by the battery.

2. The information processing apparatus according to claim 1, wherein the control unit, in a case where supply of power to the load by the power source is stopped at a power failure, controls so that supply of power to the load is executed by the battery.

3. The information processing apparatus according to claim 1, wherein the load includes at least a volatile storage unit.

4. The information processing apparatus according to claim 1, further comprising a voltage detection unit configured to detect an end-of-charge voltage of the battery, and
wherein in a case where a result of the detection by said voltage detection unit is lower than a predetermined threshold value when supply of power is started, said control unit charges the battery.

5. The information processing apparatus according to claim 1, wherein in a case where the load has predetermined image data stored therein, said control unit does not execute a power-off at the preset time or after lapse of the predetermined time period.
